(19) United States
(12) Patent Application Publication
(10) Pub. No.: US 2026/0109075 A1
(43) Pub. Date: Apr. 23, 2026

(54) Sawing device, sawing station and framing station and use of a sawing device and method for operating a sawing device

(71) Applicant: WEINMANN Holzbausystemtechnik GmbH, St Johann Wuertt (DE)

(72) Inventors: Alexander KRÄMER, Albstadt (DE); Michael GOLLER, Münsingen (DE); Oliver Raach, Reutlingen (DE); Frank Geysel, Pfronstetten (DE)

(21) Appl. No.: 19/363,752

(22) Filed: Oct. 21, 2025

(30) Foreign Application Priority Data
Oct. 21, 2024 (DE) 102024130584.3

(51) Int. Cl. B27G 19/02

(52) U.S. Cl. CPC B27G 19/025

(57) ABSTRACT

The invention relates to a sawing device for splitting up a workpiece, in particular a wooden workpiece, having a saw blade, a first drive unit, in order to set the saw blade in rotation, in particular a first electric motor, and a protective apparatus, wherein the protective apparatus is arranged at least in sections around the periphery of the saw blade in such a way that an operator located next to the sawing device can be protected against the rotating saw blade, wherein the protective apparatus comprises a movable part, wherein the movable part is arranged pivotably about the pivot point of the saw blade in such a way that, as a result of the introduction of the workpiece into the sawing device for a splitting process, the movable part is pivoted in such a way that acting of the rotating saw blade on the workpiece is enabled. Usage of the saw which is safe for an operator can be ensured by way of the measuring apparatus according to the invention.

The invention relates to a sawing device for splitting up a workpiece according to the precharacterizing clause of Claim 1, and to a sawing station and a framing station. Furthermore, the invention relates to the use of a corresponding sawing device and to a method for operating a framing station.

In timber-frame house construction, individualized fabrications of house ground plans are increasingly often being designed, which have a connection of the walls at an angle which is not 90°. For this purpose, the corresponding wooden workpieces are currently shortened manually by way of a sawing device at the corresponding angle. The sawing devices known in the marketplace have enclosures for protecting an operator, wherein the enclosures do not ensure protection for the operator in every angular position of the saw blade. In addition, these enclosures are designed in such a way that they cannot be integrated into a sawing station or a framing station.

It is therefore an object of the present invention to provide an improved sawing device, in particular a sawing device with an improved protective apparatus.

This object is achieved by the subject matter of independent Patent Claim 1. Preferred embodiments are the subject matter of the dependent patent claims.

A further concept of the present invention is to provide an improved sawing station, in particular a sawing station with a pivotable sawing device.

This object is achieved by the subject matter of independent Patent Claim 11.

A further concept of the present invention is to provide an improved framing station.

This object is achieved by the subject matter of independent Patent Claim 12. Preferred embodiments are the subject matter of the dependent claim.

A further concept of the present invention is to provide an improved method or at least an alternative method for operating a framing station. In particular, a method is intended to be proposed, in which a framing station is operated in a manner dependent on a sawing plan.

This object is achieved by the subject matter of independent Patent Claim 15. Preferred embodiments are the subject matter of the dependent claims.

Accordingly, a fundamental concept of the invention is a sawing device for splitting up a workpiece, in particular a wooden workpiece, having a saw blade, a first drive unit, in order to set the saw blade in rotation, in particular a first electric motor, and a protective apparatus, wherein the protective apparatus is arranged at least in sections around the periphery of the saw blade in such a way that an operator located next to the sawing device can be protected against the rotating saw blade, wherein the protective apparatus comprises a movable part, wherein the movable part is arranged pivotably about the pivot point of the saw blade in such a way that, as a result of the introduction of the workpiece into the sawing device for a splitting process, the movable part is pivoted in such a way that acting of the rotating saw blade on the workpiece is enabled. In this way, safe operation of a sawing device for an operator can be enabled. In one preferred refinement, the first drive unit is configured as a first electric motor. As a result of the configuration of the first drive unit in the form of an electric motor, the saw blade of the saw device cannot only be driven, but rather also braked.

Within the context of the invention, a protective apparatus is to be understood to mean an apparatus which is arranged at least in sections around the saw blade, with the result that an operator is protected against injury from the rotating saw blade.

In accordance with one preferred embodiment, the protective apparatus has a fixed housing, wherein the movable part is arranged pivotably at least in sections about the fixed housing or between the saw blade and the fixed housing, in particular is pivotable counter to the rotational direction of the saw blade.

A protective apparatus of compact design for a sawing device is provided as a result of the movable part being pivoted away in sections about the protective apparatus. In addition, it can be ensured that only that part of the saw blade which is also necessary for machining is exposed by the protective apparatus for machining a workpiece. As a result, the risk of injury for an operator is reduced.

In one particularly preferred refinement, the sawing device has a sensor, in order to monitor the pivoting of the movable part, wherein the end position point of the extended movable part is preferably monitored. As a result, it is possible that, after a machining process, the movable part is pivoted away again from the fixed housing and, when the end position point is reached, the saw blade is braked by the electric motor. In this way, the safety for an operator is increased further.

In accordance with a further preferred embodiment, the movable part has a stop and is arranged in the sawing device in such a way that the stop comes into contact with a workpiece to be machined when the workpiece is introduced into the sawing device, wherein the movable part can be moved by the workpiece in such a way that the sawing blade is exposed for a splitting process. The safety for an operator is increased further by the exposure of the saw blade only to the extent, to which the saw blade bears against the workpiece.

In accordance with a further preferred embodiment, the stop is configured as a plastic roller, wherein the plastic roller is arranged in a rotatably mounted manner on the movable part in such a way that a workpiece which is introduced into the sawing device bears against the plastic roller and can be guided along it, wherein the introduction of the workpiece preferably takes place in a main conveying direction of the workpiece to be machined, wherein the plastic roller comprises a predefined elastic material, with the result that a uniform movement of the movable part is realised, wherein the plastic roller is shaped in such a way, in particular is rounded on both sides in such a way that the plastic roller bears against the workpiece in all angular positions of the saw blade.

As a result of the configuration of the stop from an elastic material, it is possible for the protective apparatus to be adapted in a targeted manner to the contours of the workpiece. In this way, the best possible protection for an operator can be ensured.

In one preferred refinement, the plastic roller is configured from polyoxymethylene. As a result of the configuration of the plastic roller from polyoxymethylene, a plastic roller which is simple to produce and inexpensive can be provided, which is elastic in such a way that it bears against the workpiece surface without additionally damaging the workpiece surface.

In accordance with a further preferred embodiment, the protective apparatus has a spring, wherein the spring presses the movable part against a workpiece to be machined, and is arranged on the pivot point of the movable part.

This can ensure that the protective apparatus of the sawing device always bears against the workpiece to be machined and, as a consequence, ensures the greatest possible protective region.

In one preferred refinement, the spring is configured as a torsion spring. As a result, the spring can be integrated in a space-saving manner into the sawing device, as a result of which a sawing device of compact overall design can be provided.

In accordance with a further preferred embodiment, the movable part has an auxiliary device, wherein the auxiliary device assists the movement of the movable part.

As a result of the assistance of the movement with the aid of the auxiliary device, the pressing force of the movable part on the workpiece is decreased, whereby the risk of damage to the workpiece surface is reduced.

Within the context of the invention, an auxiliary device is understood to mean every type of device which assists the movement of the movable part. This can preferably be understood to mean a direct or indirect drive. In one particularly preferred refinement, the auxiliary device comprises a cable and a winding unit, wherein the winding unit is preferably spring-preloaded. In this way, a technically simple and low-maintenance auxiliary device can be provided.

In accordance with a further preferred embodiment, the saw blade can be moved in a first direction, wherein the first direction is orthogonal with respect to a sawing line in a vertical axis and orthogonal with respect to a main conveying direction of the workpiece to be machined.

The first direction therefore corresponds to a vertical axis of the sawing device, wherein the saw blade can be moved in this vertical axis with respect to the supporting table of the workpiece to be machined. This can ensure that workpieces of different size can be machined by way of the sawing device.

In accordance with a further preferred embodiment, the sawing device has a guide unit for moving the saw blade, wherein the guide unit has a first actuating drive, in particular a first electric actuating motor, for moving the saw blade.

As a result of the provision of a guide unit with a first actuating drive, the operator is at least assisted during the movement of the saw blade. In this way, a simple operation of the sawing device can be ensured.

In accordance with a further preferred embodiment, the sawing device comprises a control unit which actuates the first actuating drive in such a way that the movement of the saw blade takes place, wherein, in particular, the control unit actuates the first actuating drive in a manner dependent on a cutting plan, in order to position and to move the saw blade.

As a result of the provision of a control unit, an at least partially autonomous process for machining workpieces can be provided. For this purpose, the control unit can preferably be arranged in the region of the sawing device. As a result, it is possible that the operator can make changes to parameters in the control unit in a manner dependent on the cutting pattern of the sawing device. In a further preferred embodiment, the sawing device can have a monitoring device, in order to analyse the cutting pattern on the workpiece. The monitoring device is preferably a camera which records the cut edge of the workpiece, wherein the control unit evaluates the measured recordings and outputs a signal if the cutting pattern no longer corresponds to the required quality specifications. The signal indicates to the operator that maintenance work, in particular the replacement of the saw blade, has to be carried out on the sawing device. As a result of the integration of a monitoring device into the sawing device, a sawing device can be provided in combination with the control unit, in the case of which sawing device the proportion of reject parts is at least reduced.

In accordance with a further preferred embodiment, the sawing device has a pivot unit, wherein the pivot unit is configured in such a way that the saw blade can be pivoted in an angular range of ±85°, in particular ±65°, in relation to the first direction in the direction of the main conveying direction or in the direction of the sawing line, wherein, in particular, the pivot unit can be locked for a splitting process.

As a result, it is possible to machine workpieces not only at an approximate 90° angle, but rather to machine them at a predefined angle. As a result, in a downstream machining step, connections of the machined workpieces at an angle which is not a right angle can be provided. As a result, in particular in the case of timber-frame house construction, the freedom of design of the ground plans is increased, for example by way of polygonal bay windows.

In accordance with a further preferred embodiment, the protective apparatus has a protective plate, wherein the protective plate is arranged opposite the exposed part of the saw blade, wherein the protective plate is arranged on the sawing device, in particular on the pivot unit, in such a way that the workpiece to be machined can be positioned between the protective plate and the saw blade, wherein the protective plate is also moved and/or also pivoted during a movement and/or pivoting of the saw blade. A protective plate is understood to mean a further protective apparatus which is intended to protect an operator from the saw blade during the operation of the sawing device. The protective plate can preferably be arranged on the sawing device such that can be dismantled. In this way, the access to the saw blade can be simplified in the case of maintenance work.

The invention relates, furthermore, to a sawing station having a sawing device and a saw table with a supporting surface, onto which a workpiece to be machined can be placed, wherein the supporting surface has a cut-out, wherein the cut-out is configured in such a way that a saw blade of the sawing device can be moved in the cutout in an angular range of ±85°, preferably ±65° in relation to a first direction which is orthogonal with respect to a sawing line in a vertical axis and orthogonal with respect to a main conveying direction of the workpiece to be machined.

As a result, a sawing station can be provided which machines workpieces at an angle, in particular shortens them into a corresponding angle. In this way, abutting edges for workpieces can be provided which are at an angle with respect to a main surface of the workpiece, which angle does not equal 90°. In this way, the design freedom of connections of the workpieces can be increased. In particular in the case of timber-framed house construction, a load-bearing beam can be provided in this way, which can be connected to a further load-bearing beam at a desired and predefined angle. In this way, in particular, wall elements which lie at an angle with respect to one another can be realised, whereby the design freedom in the case of timber-framed house construction is considerably increased.

The sawing device is preferably configured in accordance with one of the above-described embodiments. In accordance with one preferred embodiment, the sawing station comprises a saw blade, a control unit and an actuating drive, wherein the control unit actuates the first actuating drive in such a way that a movement of the saw blade takes place in the first direction, wherein, in particular, the control unit actuates the first actuating drive in a manner dependent on a cutting plan, in order to position and to move the saw blade.

As a result, an at least partially automatically operating sawing station can be provided.

Furthermore, the invention relates to a framing station for producing a load-bearing structure for building walls from workpieces, in particular from wooden workpieces, having a feed table, a sawing station, a removal table, a fastening unit and a control unit, wherein the sawing station is arranged in a workpiece conveying direction between the feed table and the removal table in the region of the fastening unit in such a way that a workpiece can be split up, in particular can be shortened, by means of the sawing station for the load-bearing structure to be produced, and can be fastened to the load-bearing structure by means of the fastening unit.

The feed table and the removal table are preferably each assigned a conveying device. As a result of the arrangement of the sawing device between a first conveying device of the feed table and a further conveying device of the removal table, an at least partially automatic introduction and discharge of a workpiece can be provided.

The sawing station is preferably configured in accordance with one of the previous embodiments. The conveying devices are particularly preferably configured as chain conveyors, wherein the individual chain segments preferably comprise a plastic or have a plastic surface which can be attached. As a result, damage to the workpieces can be avoided or at least reduced.

In accordance with a further preferred embodiment of the framing station, the first conveying device has two conveying segments, in order to convey two workpieces at least approximately parallel with respect to one another to the sawing station, wherein the sawing station has two sawing devices, wherein the sawing devices are arranged on or at least in the region of the conveying segments in such a way that machining of the two workpieces can be carried out, wherein the sawing devices can be actuated by the control unit in such a way that machining of the two workpieces takes place at least approximately at the same time.

The two workpieces are preferably wooden workpieces and serve as load-supporting structure beams of a load-bearing structure to be produced of a building wall, wherein the framing station has an intermediate beam feed and orientation apparatus for intermediate beams downstream of the sawing station in the workpiece conveying direction, wherein the intermediate beams are oriented at a defined spacing with respect to one another between an upper load-bearing structure beam and a lower load-bearing structure beam, wherein the framing station has a fastening unit, in order to connect the intermediate beams to the load-bearing structure beams.

As a result, a framing station can be provided, by way of which load-bearing structures for building walls can be manufactured with individual dimensional specifications.

In accordance with a further preferred embodiment of the framing station, the sawing station comprises a saw blade and an actuating drive, wherein the control unit actuates the first actuating drive in such a way that a movement of the saw blade takes place in a first direction, wherein the first direction is orthogonal with respect to the sawing line of the framing station in a vertical axis and orthogonal with respect to a main conveying direction of the workpiece to be machined, wherein, in particular, the control unit actuates the first actuating drive in a manner dependent on a cutting plan, in order to position and to move the saw blade. As a result, an at least partially automatically operating framing station can be provided which processes, in particular, a predefined cutting plan. In this way, an operator can be at least assisted during the processing of a cutting plan.

The invention also relates to the use of a sawing device, wherein an operator inputs a sawing plan for a workpiece to be machined into a control unit, sets it up by means of the control unit and/or selects it by means of the control unit and subsequently starts a machining process at the sawing device, by the operator actuating at least two activation buttons, in particular two two-hand activation buttons, wherein the activation buttons have to remain actuated during the machining process.

The use of the sawing device is understood to mean switching on and operating the sawing device. As a result of the configuration of the activation buttons in the form of two separate activation buttons, increased safety during operation of the sawing device is ensured, since the risk of accidentally switching on the sawing device by actuating at least two buttons can be at least minimized. As a result of the configuration of the activation buttons as two-hand activation buttons, particular protection for the hands of the operator is ensured. In this way, safe handling by way of the sawing device can be increased further.

The sawing device is preferably configured in accordance with one of the above-described embodiments.

Furthermore, the invention also relates to a method for operating a framing station, having the following steps: setting a saw blade in rotation for splitting up a workpiece, in particular a wooden workpiece, introducing the workpiece into the sawing device, pivoting a movable part of a protective apparatus of the sawing device as a result of the introduction of the workpiece about a pivot point of the saw blade, with the result that the rotating saw blade can act on the workpiece for a splitting process.

As a result, a method for operating a framing station with a sawing device is provided.

In accordance with one preferred embodiment of the method, the method has, furthermore, the following steps: providing information relating to the workpieces to be machined in a control unit, setting up a sawing plan in the control unit on the basis of the provided information, starting the sawing device, actuating the sawing device in a manner dependent on the sawing plan, wherein the saw blade of the sawing device is moved and/or pivoted partially automatically or fully automatically in a manner dependent on the sawing plan by a predefined angle in relation to a first direction which is orthogonal with respect to a sawing line of the sawing device in a vertical axis and orthogonal with respect to a main conveying direction of the workpiece to be machined.

As a result, a method is provided which processes a sawing plan which has been planned in advance by an operator. With the aid of partially automatic pivoting of the saw blade, the saw blade can be moved into the corresponding angular position for an operator, whereby the operator merely has to lock the saw blade in this angular position. As a result of the fully automatic pivoting of the saw blade, fully automatic operation of the framing station can be provided. In this way, it is possible to provide 24 hour operation of the station without an operator being required for the operation.

The framing station and/or the sawing device are/is preferably configured in accordance with one of the above-described embodiments.

In accordance with a further preferred embodiment of the method, the protective apparatus is moved and/or pivoted with the saw blade in a manner dependent on a movement and/or pivoting of the saw blade.

As a result of the use of a protective apparatus on the sawing device, an operator can be safely protected against the saw blade which is in operation. As a result, it is possible that an operator can stay inside or at least in the region of the framing station during the operation of the sawing device. As a result of the pivoting of the saw blade, the workpieces can be shortened at a corresponding angle on the end regions. As a result, a great design freedom for connections of workpieces can be provided. As a result of the protective apparatus also being pivoted and/or moved, it can be ensured that the operator is protected from the saw blade in every setting of the saw blade.

Further important features and advantages of the invention result from the subclaims, from the drawings and from the associated description of the figures on the basis of the drawings.

It goes without saying that the features which are mentioned above and which are still to be explained in the following text can be used not only in the respective specified combination, but rather also in other combinations or on their own, without departing from the scope of the present invention.

Preferred exemplary embodiments of the invention are shown in the drawings and will be explained in greater detail in the following description, wherein identical reference numerals refer to identical or similar or functionally identical components.

In the drawings, in each case diagrammatically:

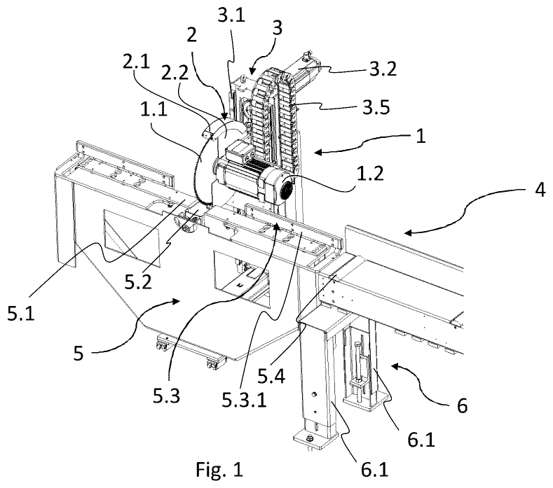

FIG. 1 shows a first exemplary embodiment of a sawing device according to the invention,

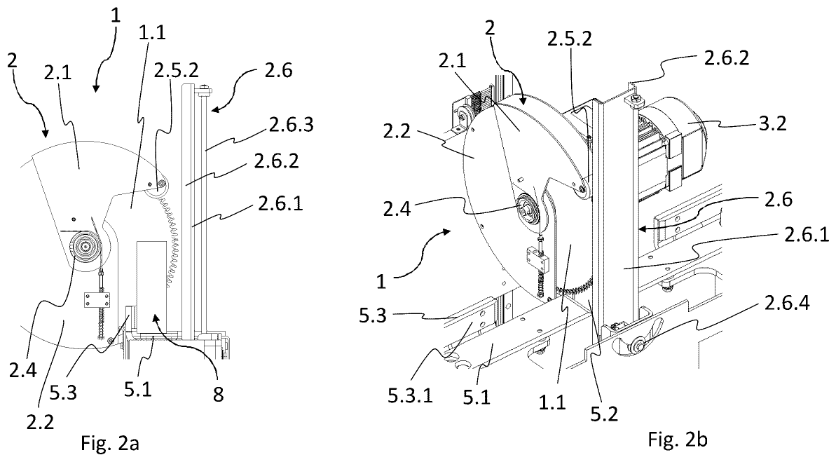

FIG. 2a shows a first detailed view of a sawing device according to the invention,

FIG. 2b shows a second detailed view of a sawing device according to the invention,

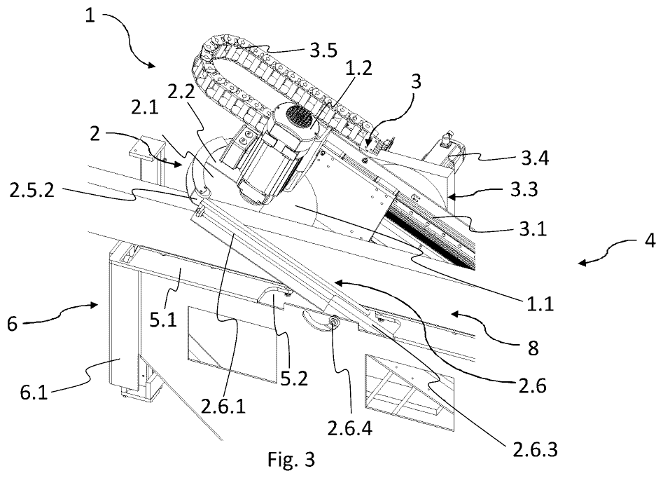

FIG. 3 shows a third detailed view of a pivoted sawing device according to the invention, and

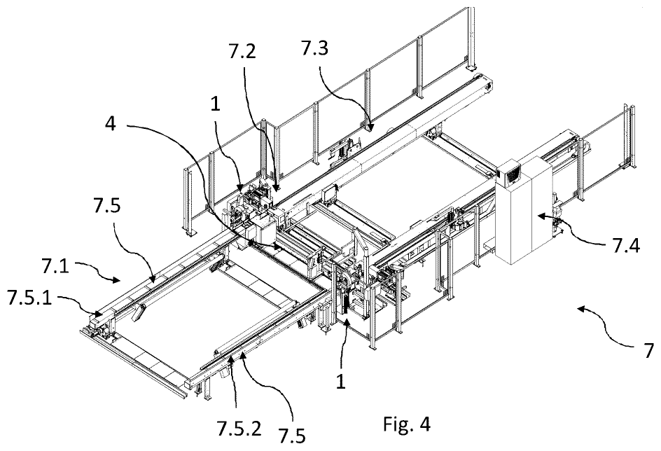

FIG. 4 shows a machining apparatus having a sawing device according to the invention.

In different forms of representation, FIG. 1 to FIG. 3 each show one exemplary embodiment of a sawing device according to the invention.

FIG. 1 shows a first exemplary embodiment of a sawing device 1 according to the invention as a constituent part of a sawing station 4. Here, the sawing device 1 has a saw blade 1.1 and a first drive unit 1.2. The first drive unit 1.2 is actuated by a actuation unit (not shown) and is preferably driven in a speed-controlled manner for the corresponding application. Wooden workpieces can preferably be split up, in particular shortened, by way of the sawing device 1. Depending on the saw blade 1.1 which is used, the sawing device can also be used for other materials such as, for example, metal, plastics and/or concrete materials.

Furthermore, the sawing device 1 has a protective apparatus 2 which extends around the saw blade 1.1. The protective apparatus 2 serves to protect an operator who is situated in the region of the sawing device 1 from the saw blade 1.1 which is in operation. For this purpose, the protective apparatus 2 comprises a fixed housing 2.2 and a movable part 2.1. The fixed housing 2.2 extends around a part of the saw blade 1.1 in such a way that the saw blade 1.1 is accessible in the direction of a saw table 5 for a workpiece (not shown). The movable part 2.1 serves to cover or to expose as required that part of the saw blade which is not covered by the fixed housing 2.2. For this purpose, the movable part 2.1 can be pivoted about the pivot point of the saw blade 1.1. As shown in the present case in FIG. 1, the movable part 2.1 can be pivoted at least partially about the fixed housing 2.2. In an alternative variant (not shown), the movable part 2.1 can also be pivoted away between the saw blade 1.1 and the fixed housing 2.2, that is to say can be pivoted within the fixed housing 2.2. Pivoting of the movable part 2.1 preferably takes place counter to the rotational direction of the saw blade 1.1. The movable part 2.1 is pivoted about the fixed housing 2.2 for exposing the saw blade 1.1 only to such an extent that a workpiece to be machined can be machined by way of the saw blade 1.1. In this way, the safety for an operator can be ensured as best as possible. Pivoting of the movable part 2.1 can be assisted by way of an auxiliary device (not shown), for example a drive device.

In the exemplary embodiment according to FIG. 1, the sawing device 1 is part of a sawing station 4. Furthermore, the sawing station 4 has a saw table 5. The saw table 5 comprises at least one supporting surface 5.1 for a workpiece to be sawn. In addition, the saw table comprises conveying rollers 5.4 which protrude out of the supporting surface 5.1. The conveying rollers 5.4 serve to at least reduce the friction between the workpiece and the supporting surface 5.1, in order to minimize the risk of damage to the workpiece. In order that the workpiece can be fed to the sawing device 1 in a positioned manner, the saw table 5 has an orienting element 5.3 in the form of a triangle. The orienting element 5.3 has an orienting surface 5.3.1, against which a workpiece can be placed for positioning. In addition, the supporting surface 5.1 of the saw table 5 has cut-outs 5.2. The cut-outs are designed in such a way that the saw blade 1.1 of the sawing device 1 can engage for a sawing operation and does not come into contact with the supporting surface 5.1. In this way, it can be ensured that a workpiece can be split up completely without the saw blade 1.1 or the supporting table 5.1 being damaged. Furthermore, the saw table 5 has a support frame 6 with height-adjustable support feet 6.1. In this way, it is possible for the height of the sawing station 4 to be adjusted for an operator. By way of the height adaptation of the support feet 6.1, the sawing station 4 can likewise be set with respect to a further machining apparatus in such a way that a stepless transfer of a workpiece from or to the further machining apparatus to or from the sawing station 4 is possible.

The sawing device 1 according to FIG. 1 is arranged movably on a holder 3. The holder 3 has a guide unit 3.1 and a first actuating drive 3.2 for a movement of the sawing device 1. In this way, the sawing device can be moved in a first direction. In the present case, the first direction corresponds to a direction orthogonal with respect to the sawing line in a vertical axis and orthogonal with respect to a main conveying direction of the workpiece to be machined. In this way, the sawing device can be moved relative to the supporting surface 5.1. As a result, the sawing device 1 is suitable for machining workpieces of different dimensions, in particular workpieces of different height. Furthermore, the holder 3 has a pivot unit 3.3 and a second actuating drive 3.4 (not shown in FIG. 1). In this way, the sawing device 1 can be pivoted in the advancing direction of the workpiece. In this way, a sawing cut can be carried out on the workpiece in an angular range of ±85°, preferably ±65°. In order for it to be possible for the freedom of movement of the sawing device 1 to be ensured, the holder has a cable guide 3.5 which moves with the guide unit 3.1 and can be pivoted with the pivot unit 3.3. As a result of the arrangement of the sawing device 1 on the holder 3, a particularly flexibly usable sawing device 1 can be provided, by way of which workpieces of different dimensions can be machined.

FIGS. 2a and 2b each show a detailed view of a sawing device 1 according to the invention. Just like the exemplary embodiment according to FIG. 1, the exemplary embodiments according to FIGS. 2a and 2b can be a constituent part of a sawing station. The sawing device 1 according to FIG. 2a has a saw blade 1.1 and a protective apparatus 2. The protective apparatus 2 comprises a fixed housing 2.2 and a movable part 2.1 which extend at least partially around the saw blade 1.1. The movable part 2.1 can be moved about the fixed housing, as in the exemplary embodiment according to FIG. 1, in such a way that the saw blade can be exposed for machining a workpiece 8. If there is no workpiece for machining, the movable part 2.1 is arranged around the saw blade 1.1 in a closed position in such a way that the fixed housing 2.2 and the movable part 2.1 of the protective apparatus 2 enclose the entire saw blade 1.1 at least approximately. For this purpose, the movable part 2.1 is preloaded with the aid of a spring 2.4 in such a way that the movable part 2.1 remains in the closed position. The movable part 2.1 can be moved about the fixed housing 2.2 with the aid of an auxiliary device (not shown in the exemplary embodiment according to FIG. 2a) in such a way that the saw blade 1.1 is exposed. Here, that region of the saw blade 1.1 is intended to be exposed which is required for machining a workpiece 8. For this purpose, a roller 2.5.2 is arranged on that part of the movable part 2.1 which is directed towards the workpiece. In the present exemplary embodiment, the roller 2.5.2 is configured as a plastic roller and is rounded towards the side flanks. The roller 2.5.2 bears against the workpiece 8 to be machined, in order to ensure that the movable part 2.1 of the protective apparatus 2 exposes only that part of the saw blade 1.1 which is necessary for machining the workpiece 8.

Furthermore, the sawing device 1 according to FIG. 2a has a protective plate 2.6. This protective plate 2.6 is arranged opposite the exposed saw blade 1.1. A workpiece 8 to be machined can be introduced between the protective plate 2.6 and the saw blade 1.1. The protective plate 2.6 serves to protect an operator as far as possible against the saw blade portion which is exposed for machining. For this purpose, the protective plate 2.6 has a movable protective plate part 2.6.1 which is arranged movably on a protective plate guide unit 2.6.3. At the edges, the movable protective plate part 2.6.1 has side cheeks 2.6.2 which extend in the direction of the saw blade 1.1. In this way, the protection of an operator against the saw blade 1.1 is intended to additionally be increased. As a result of the arrangement of the movable protective plate part 2.6.1 on the protective plate guide unit 2.6.3, the height of the movable protective plate part 2.6.1 can be varied. In this way, it is possible that the height of the movable protective plate part 2.6.1 varies in a manner dependent on the exposed saw blade portion. In order to orient the workpiece 8 correctly for a saw cut in the sawing device 1, the workpiece 8 is fed to the saw blade on the supporting surface 5.1 and is positioned on the orienting element 5.3 for the cut.

The exemplary embodiment according to FIG. 2b shows a sawing device 1 in a three-dimensional detailed view. The sawing device 1 has a saw blade 1.1 and a protective apparatus 2 which is identical to the protective apparatus in accordance with the exemplary embodiment according to FIG. 2a. Furthermore, the sawing device 1 has a protective plate 2.6. The protective plate 2.6 comprises a movable protective plate part 2.6.1 which, at each of the two lateral ends, has a side cheek 2.6.2 which extends towards the saw blade. Furthermore, the protective plate has a protective plate guide unit 2.6.3, in order for it to be possible for the movable protective plate part 2.6.1 to be moved in the first direction. The movement is preferably carried out with the aid of a drive unit (not shown). The drive unit can be configured as an electric motor. As a result, a highly exact setting of the position in the first direction of the movable protective plate part 2.6.1 is possible. In order to set the correct position in the first direction of the movable protective plate part 2.6.1, a control unit (not shown) can be provided which actuates the drive unit on the basis of predefined or determined information of the workpiece 8 to be machined, in such a way that the movable protective plate part 2.6.1 is moved. An actuation of the drive unit for the movement of the movable protective plate part 2.6.1 in a manner dependent on the pivot angle of the movable part 2.1 of the protective apparatus 2 of the sawing device 1 is likewise possible.

Furthermore, the sawing device 1 in accordance with the exemplary embodiment of FIG. 2b has a pivot device 2.6.4 of the movable protective plate part 2.6.1. The pivot device 2.6.4 comprises a mechanism in the form of a semicircular cut-out and a pivot pin which is arranged movably in the semicircular cut-out.

The pivot pin is connected to the movable protective plate part 2.6.1. In the case of a movement of the pivot pin, this is guided in the mechanism in such a way that the movable protective plate part 2.6.1 can be moved in a guided manner. The pivot pin is preferably connected to a pivot unit (not shown) of the saw blade 1.1. It can be ensured with the aid of the coupling of the pivot pin of the pivot device 2.6.4 of the protective plate 2.6 that the protective plate 2.6 is pivoted with the saw blade 1.1. In this way, best possible protection for an operator can be ensured, even in the case of a pivoted saw blade 1.1.

FIG. 3 shows a third detailed view of a pivoted sawing device 1 according to the invention which is part of a sawing station 4. The sawing device 1 has a saw blade 1.1 and a first drive unit 1.2, in order to drive the saw blade 1.1. In addition, the sawing device 1 has a protective apparatus 2, in order to protect an operator against the saw blade 1.1. The protective apparatus 2 has a fixed housing 2.2 and a movable part 2.1 which can be moved about the fixed housing 2.2. Furthermore, the protective apparatus has an auxiliary device 2.5 (not shown), in order to move the movable part 2.1 about the fixed housing 2.2. The movable part 2.1 has a roller 2.5.2 in the contact region with the workpiece 8. Furthermore, the protective apparatus 2 has a protective plate 2.6, in order to protect an operator against the saw blade 1.1. The saw blade 1.1 is arranged on a holder 3 of the sawing station 3. The holder 3 has a guide unit 3.1, in order to move the saw blade 1.1 translationally in the first direction. The movement in the first direction is realized by a first actuating drive (not shown). As a result of the use of a first actuating drive, exact positioning of the saw blade can take place. In the case of a movement of the saw blade 1.1 in the first direction, the movable protective blade part 2.6.1 can be moved in the first direction at the same time or at least nearly the same time with the aid of the protective plate guide unit 2.6.3 in such a way that an operator is protected against the saw blade 1.1. The movement of the movable protective plate part 2.6.1 is preferably coordinated with the movement of the saw blade 1.1 in such a way that the movable protective plate part 2.6.1 and the saw blade 1.1 are moved to the same position in the first direction. Furthermore, the holder 3 has a pivot unit 3.3, in order to move the saw blade 1.1 in an angular range of ±85°. For specific applications, the saw blade 1.1 can preferably be moved with the aid of the pivot unit 3.3 in an angular range of ±65°. For the movement, a second actuating drive 3.2 is arranged on the pivot unit 3.3. The second actuating drive 3.2 is actuated via a control unit (not shown) in accordance with a predefined cutting plan. As a result, the saw blade 1.1 can be moved into the corresponding angular position in accordance with the cutting plan. In order for it to be possible for the first drive unit 1.2 to be connected to a control unit and/or to a current supply even in the case of a movement of the saw blade 1.1, the holder 3 has a flexible cable guide 3.5. The cable guide 3.5 comprises individual elements which can be moved with respect to one another, in order to neither clamp nor overstretch the cables guided therein upon a movement. In this way, a cable fracture of the supply cables can be prevented.

In addition to the sawing device 1, the sawing station 4 in accordance with the exemplary embodiment according to FIG. 3 has a saw table 5. In the present case, the sawing device 1 is fastened to the saw table 5. In one alternative embodiment (not shown), the sawing device 1 can be arranged on a pedestal or on the floor next to the saw table 5 in such a way that the sawing device 1 can machine a workpiece 8 which is situated on the saw table 5. The saw table 5 has a supporting surface 5.1 for a workpiece 8. In one embodiment of the supporting surface 5.1, it can have rollers or sliding elements, in order to simplify a movement of the workpiece 8 on the supporting surface 5.1.

The sliding elements are preferably arranged replaceably on the supporting surface 5.1 and comprise a plastic. The supporting surface 5.1 has a cut-out of 5.2 in the machining region of the sawing device 1. The cut-out 5.2 is designed in such a way that the saw blade 1.1 can engage into the cutout 5.2 for a sawing cut, without the saw blade coming into contact with the supporting surface 5.1. As a result, correct machining of the workpiece 8 can be carried out without the saw blade 1.1 and/or the supporting surface 5.1 of the saw table 5 being damaged. In the present case, the saw table 5 is arranged on a support frame 6. The support frame 6 has support feet 6.1, in order to fasten the support frame 6 to the floor. In the present exemplary embodiment, the support feet are height-adjustable, in order to orient the saw table 5.

FIG. 4 shows a machining apparatus in the form of a framing station 7 with a sawing station 4 according to the invention comprising two sawing devices 1. Furthermore, the framing station 7 has a fastening unit 7.2, a removal table 7.3 and a control unit 7.4. The framing station 7 is configured to produce a load-bearing structure for, for example, a building from workpieces, preferably from square workpieces comprising wood or a wood composite material.

A load-bearing structure usually comprises two at least approximately parallel workpieces, what are known as the load-bearing structure beams, which are also called an upper and lower chord. Further workpieces, what are known as collar ties, are inserted into the space between the upper and lower chord. The collar ties are introduced at least approximately orthogonally with respect to the lateral surfaces of the upper and/or lower chord, wherein the respective collar ties are arranged at a predefined spacing from one another. For this purpose, the framing station 7 has a feed table 7.1. The feed table 7.1 is configured to feed the upper and lower chord to the corresponding sawing device 1. For this purpose, the feed table 7.1 has a first conveying device 7.5, comprising a first and second conveying segment 7.5.1, 7.5.2. The first conveying segment 7.5.1 is configured to move the upper chord. The second conveying segment 7.5.2 is configured to move the lower chord. In one variant, the first and/or second conveying segment 7.5.1, 7.5.2 can be configured as a chain conveyor, in order to move the workpieces. Chain conveyors are particularly suitable for conveying an upper and/or lower chord, since they are of particularly robust configuration and can move heavy components precisely. After the feed of the upper and lower chord, the upper and lower chord are split up, in particular shortened, to a predefined length with the aid of the sawing devices 1 for the load-bearing structure to be produced. The upper and lower chord can preferably also be shortened at a predefined angle, preferably in an angular range of up to ±85°, by the corresponding saw blade of the respective sawing device 1 being pivoted at the corresponding angle. As a result, it is possible to produce load-bearing structures for corner connections and/or sloping roofs. The sawing devices 1 each have a protective apparatus (not shown in greater detail) in accordance with the embodiments according to FIG. 1 to FIG. 3, in order to protect an operator, who is situated in the region of the sawing station 4 for the operation of the framing station 7, against the saw blades of the sawing devices 1.

A fastening unit 7.2 is arranged positioned downstream of the sawing station 4 in the workpiece conveying direction. In the region of the fastening unit 7.2, the collar ties (not shown) are introduced into the space between the upper and lower chord by an operator (not shown) or a manipulator, and are connected to the upper and lower chord by means of the fastening unit 7.2. For this purpose, the upper and lower chord are moved with the aid of the first conveying device sequentially in the workpiece conveying direction in such a way that the predefined spacing of the introduced collar ties from one another is maintained. In one variant, the fastening unit 7.2 has two nailing stations, wherein one nailing station is arranged on the side of the upper chord and the further nailing station is arranged on the side of the lower chord in such a way that the respective nailing station can introduce a nail through the upper or lower chord into the collar tie which is arranged between the upper and lower chord.

As a result of the sequential movement of the upper and lower chord in conjunction with the sequential insertion and fastening of the collar ties, the load-bearing structure is produced sequentially and is conveyed onto the removal table 7.4. In one variant, the removal table 7.4 has a further conveying device in the form of rollers (not shown). In an alternative variant, the removal table has an approximately planar surface. The planar surface can preferably have an additional sliding layer, in particular a replaceable sliding layer. In the present case, a plastic layer comes into question as a sliding layer, which can be fastened to the planar surface, preferably with the aid of screws. In addition, the removal table 7.4 can have a movable stopping device (not shown). In one variant, the stopping device is configured in the form of a stop pin. The stop pin can be moved with the aid of a rail system (not shown). The rail system is preferably arranged on a lateral surface of the removal table.

Furthermore, the framing station 7 has a control unit 7.4. This serves to actuate the individual devices and units of the framing station 7. Furthermore, the control unit 7.4 is configured so as to actuate the sawing devices 1 in such a way that machining of the upper and lower chord takes place at least approximately at the same time.

### LIST OF REFERENCE NUMBERS

1 Sawing device
1.1 Saw blade
1.2 First drive unit
2. Protective apparatus
2.1 Movable part
2.2 Fixed housing
2.3 Stop
2.4 Spring
2.5 Auxiliary device
2.5.1 Cable pull
2.5.2 Roller
2.6 Protective plate
2.6.1 Movable protective plate part
2.6.2 Side cheeks
2.6.3 Protective plate guide unit
2.6.4 Pivot device, protective plate
3 Holder
3.1 Guide unit
3.2 First actuating drive
3.3 Pivot unit
3.4 Second actuating drive
3.5 Cable guide
4 Sawing station
5 Saw table
5.1 Supporting surface
5.2 Cut-out
5.3 Orienting element
5.3.1 Orienting surface
5.4 Conveying roller
6 Support frame
6.1 Support feet
7 Framing station
7.1 Feed table
7.2 Fastening unit
7.3 Removal table
7.4 Control unit
7.5 First conveying device
7.5.1 First conveying segment
7.5.2 Second conveying segment
8 Workpiece

1. A sawing device for splitting up a workpiece, in particular a wooden workpiece, having a saw blade, a first drive unit, in order to set the saw blade in rotation, in particular a first electric motor, and a protective apparatus, wherein the protective apparatus is arranged at least in sections around the periphery of the saw blade in such a way that an operator located next to the sawing device is protected against the rotating saw blade, wherein the protective apparatus comprises a movable part, wherein the movable part is arranged pivotably about the pivot point of the saw blade in such a way that, as a result of the introduction of the workpiece into the sawing device for a splitting process, the movable part is pivoted in such a way that acting of the rotating saw blade on the workpiece is enabled.

2. The sawing device according to claim 1, wherein the protective apparatus has a fixed housing, wherein the movable part is arranged pivotably at least in sections about the fixed housing or between the saw blade and the fixed housing, in particular is pivotable counter to the rotational direction of the saw blade.

3. The sawing device according to claim 1, wherein the movable part has a stop and is arranged in the sawing device in such a way that the stop comes into contact with the workpiece to be machined when the workpiece is introduced into the sawing device, wherein the movable part (can be moved by the workpiece in such a way that the sawing device is exposed for the splitting process.

4. The sawing device according to claim 3, wherein the stop is configured as a plastic roller, wherein the plastic roller is arranged in a rotatably mounted manner on the movable part in such a way that a workpiece which is introduced into the sawing device bears against the plastic roller and can be guided along it, wherein the introduction of the workpiece preferably takes place in a main conveying direction of the workpiece to be machined, wherein the plastic roller comprises a predefined elastic material, in particular polyoxymethylene, with the result that a uniform movement of the movable part is realised, wherein the plastic roller is shaped in such a way, in particular is rounded on both sides in such a way that the plastic roller bears against the workpiece in all angular positions of the saw blade.

5. The sawing device according to claim 3, wherein the protective apparatus has a spring, wherein the spring presses the movable part against a workpiece to be machined, wherein the spring is preferably configured as a torsion spring and is arranged on the pivot point of the movable part.

6. The sawing device according to claim 3, wherein the movable part has an auxiliary device, wherein the auxiliary device assists the movement of the movable part, wherein the auxiliary device preferably comprises a cable pull and a winding unit, wherein the winding unit is preferably spring-preloaded.

7. The sawing device according to claim 1, wherein the saw blade can be moved in a first direction, wherein the first direction is orthogonal with respect to a sawing line in a vertical axis and orthogonal with respect to a main conveying direction of the workpiece to be machined.

8. The sawing device according to claim 7, wherein the sawing device has a guide unit for moving the saw blade, wherein the guide unit has a first actuating drive, in particular a first electric actuating motor, for moving the saw blade.

9. The sawing device according to claim 8, wherein the sawing device comprises a control unit which actuates the first actuating drive in such a way that the movement of the saw blade takes place, wherein, in particular, the control unit actuates the first actuating drive in a manner dependent on a cutting plan, in order to position and to move the saw blade.

10. The sawing device according to claim 7, wherein the sawing device has a pivot unit, wherein the pivot unit is configured in such a way that the saw blade can be pivoted in an angular range of ±85°, in particular ±65°, in relation to the first direction in the direction of the main conveying direction or in the direction of the sawing line, wherein, in particular, the pivot unit can be locked for a splitting process.

11. The sawing device according to claim 1, wherein the protective apparatus has a protective plate, wherein the protective plate is arranged opposite the exposed part of the saw blade, wherein the protective plate is arranged on the sawing device, in particular on the pivot unit, in such a way that the workpiece to be machined can be positioned between the protective plate and the saw blade, wherein the protective plate is also moved and/also pivoted during a movement and/or pivoting of the saw blade.

12. A sawing station having the sawing device according to claim 1, and a saw table with a supporting surface, on which a workpiece to be machined can be placed, wherein the supporting surface has a cut-out, wherein the cut-out is configured in such a way that a saw blade of the sawing device can be moved in the cutout in an angular range of ±85° in relation to a first direction which is orthogonal with respect to a sawing line in a vertical axis and orthogonal with respect to the main conveying direction of the workpiece to be machined.

13. The sawing station according to claim 12, wherein the sawing station comprises a saw blade, a control unit and an actuating drive, wherein the control unit actuates the first actuating drive in such a way that a movement of the saw blade takes place in the first direction, wherein, in particular, the control unit actuates the first actuating drive in a manner dependent on a cutting plan, in order to position and to move the saw blade.

14. A framing station for producing a load-bearing structure for building walls from workpieces, in particular from wooden workpieces, having a feed table with preferably a first conveying device, the sawing station according to claim 12, a removal table with preferably a further conveying device, a fastening unit and a control unit, wherein the sawing station is arranged in a workpiece conveying direction between the feed table and the removal table in the region of the fastening unit in such a way that a workpiece can be split up, in particular can be shortened, by means of the sawing station for the load-bearing structure to be produced, and can be fastened to the load-bearing structure by means of the fastening unit.

15. The framing station according to claim 14, wherein the first conveying device has two conveying segments, in order to convey two workpieces at least approximately parallel with respect to one another to the sawing station, wherein the sawing station has two of the sawing devices according to claim 1, wherein the sawing devices are arranged on or at least in the region of the two conveying segments in such a way that machining of the two workpieces can be carried out, wherein the sawing devices can be actuated by the control unit in such a way that machining of the two workpieces takes place at least approximately at the same time.

16. The framing station according to claim 14, wherein the sawing station comprises a saw blade and an actuating drive, wherein the control unit actuates the first actuating drive in such a way that a movement of the saw blade takes place in a first direction, wherein the first direction is orthogonal with respect to the sawing line of the framing station in a vertical axis and orthogonal with respect to a main conveying direction of the workpiece to be machined, wherein, in particular, the control unit actuates the first actuating drive in a manner dependent on the cutting plan, in order to position and to move the saw blade.

17. Use of the sawing device according to claim 1, wherein an operator inputs a sawing plan for a workpiece to be machined into a control unit, sets it up by means of the control unit and/or selects it by means of the control unit and subsequently starts a machining process at the sawing device, by the operator actuating at least two activation buttons, in particular two two-hand activation buttons, wherein the activation buttons have to remain actuated during the machining process.

18. A method for operating a sawing device comprising:
setting a saw blade in rotation for splitting up a workpiece, in particular a wooden workpiece,
introducing the workpiece into the sawing device,
pivoting a movable part of a protective apparatus of the sawing device as a result of the introduction of the workpiece about a pivot point of the saw blade, with the result that the rotating saw blade can act on the workpiece for a splitting process.

19. The method according to claim 18, furthermore having the following steps:
providing information relating to the workpieces to be machined in a control unit,
setting up a sawing plan in the control unit on the basis of the provided information,
starting the sawing device,
actuating the sawing device in a manner dependent on the sawing plan,
wherein the saw blade of the sawing device is moved and/or pivoted partially automatically or fully automatically in a manner dependent on the sawing plan by a predefined angle in relation to a first direction which is orthogonal with respect to a sawing line of the sawing device in a vertical axis and orthogonal with respect to a main conveying direction of the workpiece to be machined.

20. The method according to claim 18, wherein the protective apparatus is moved and/or pivoted with the saw blade in a manner dependent on a movement and/or pivoting of the saw blade.
